(19) United States
(12) Patent Application Publication
(10) Pub. No.: US 2009/0293564 A1
(43) Pub. Date: Dec. 3, 2009

(54) Lock and Associated Key

(75) Inventor: Enzo Talamonti, Ascoli Piceno (IT)

Correspondence Address: MODIANO & ASSOCIATI, Via Meravigli 16, Milan, 20123, IT

(73) Assignee: CISA S.P.A., Faenza (IT)

(21) Appl. No.: 12/308,111

(22) PCT Filed: Jun. 5, 2007
(86) PCT No.: PCT/EP2007/004978

§ 371 Date: Dec. 8, 2008

(30) Foreign Application Priority Data
Jun. 14, 2006 (EP) 06425402.2

(51) Int. Cl. E05B 27/10; E05B 9/04

(52) U.S. Cl. 70/373

(57) ABSTRACT

A lock with associated key, of the type comprising a stator provided with a substantially cylindrical longitudinal cavity for accommodating a rotor with a longitudinal recess for the insertion of a coded key. The rotor and the stator comprise a plurality of channels which accommodate respective pins, complementary pins and optional elastic elements. At least one of the pins has at least one substantially lateral protruding tab, whose upper edge is suitably contoured. The key has a cross-section that is complementary to the cross-section of the longitudinal recess when the pins, at the regions aligned with the tab, are in a configuration for disengaging the stator and the rotor, accommodating with contact the end of the pins in respective coding recesses and the contoured rim of the corresponding tab on complementarily shaped portions.

The present invention relates to a lock with an associated key suitable for installation in doors, entrance doors and in all applications in which a key-controlled closure is provided.

### BACKGROUND OF THE INVENTION

There are various kinds of lock with respective keys, which achieve the task of closing securely a door by using a variety of different solutions against any picking attempts.

Among cylinder locks, there is considerable interest in those which have a keyway (and therefore also the corresponding key) which are substantially flat and in which the pins designed to detect the key act substantially transversely with respect to the keyway (thus acting on flat portions of the key).

These locks are generally identified by the type of key associated with them and are known as flat-key locks.

The risk of picking is avoided by means of the complex coding of the lock and of the key: particular picking actions allow to actuate the pins to open the lock even without the original key.

In view of the small dimensions of a lock of the type being considered, it is substantially not possible to increase the number of pins in order to ensure greater security against picking.

### SUMMARY OF THE INVENTION

The aim of the present invention is to provide a lock with corresponding key of traditional size which is provided with portions adapted to increase the complexity of any picking actions.

Within this aim, an object of the present invention is to provide a lock with corresponding key which has a low cost and is relatively simple to provide in practice and safe in application.

This aim and this and other objects, which will become better apparent hereinafter, are achieved by the present lock with associated key, of the type comprising a stator provided with a substantially cylindrical longitudinal cavity for accommodating a rotor with a longitudinal recess for the insertion of a coded key, said rotor and said stator comprising a plurality of channels, which are substantially aligned and face each other when the cylinder is in the closed configuration, channels for accommodating respective pins, complementary pins and optional elastic means intended to prevent the rotation of the rotor within the stator if the key is not present in said longitudinal recess, characterized in that at least one of said pins has at least one substantially lateral protruding tab, whose upper rim is suitably contoured, and in that said key has a cross-section that is complementary to the cross-section of the longitudinal recess when said pins, at the regions aligned with said tab, are in a configuration for disengaging the stator and the rotor, accommodating with contact the end of said pins in respective coding recesses and the contoured rim of the corresponding tab on complementarily shaped portions.

### BRIEF DESCRIPTION OF THE DRAWINGS

Further characteristics and advantages of the invention will become better apparent from the following detailed description of a preferred but not exclusive embodiment of a lock with associated key, illustrated by way of non-limiting example in the accompanying drawings, wherein:

FIG. 1 is a side view of the cylinder of a lock with associated key according to the invention;

FIG. 2 is a front view of a lock according to the invention;

FIG. 3 is a front view of a lock according to the invention in the closed configuration;

FIG. 4 is a front view of a lock according to the invention, with the associated key inserted therein;

FIG. 5 is an exploded front view of a lock according to the invention with the associated key;

FIG. 6 is a front view of a lock according to the invention with the corresponding key arranged alongside;

FIG. 7 is a front view of a first possible embodiment of a pin of a lock according to the invention;

FIG. 8 is a front view of a second possible embodiment of a pin of a lock according to the invention;

FIG. 9 is a front view of a third possible embodiment of a pin of a lock according to the invention;

FIG. 10 is a front view of a fourth possible embodiment of a pin of a lock according to the invention;

FIG. 11 is a front sectional view of a key of a lock according to the invention.

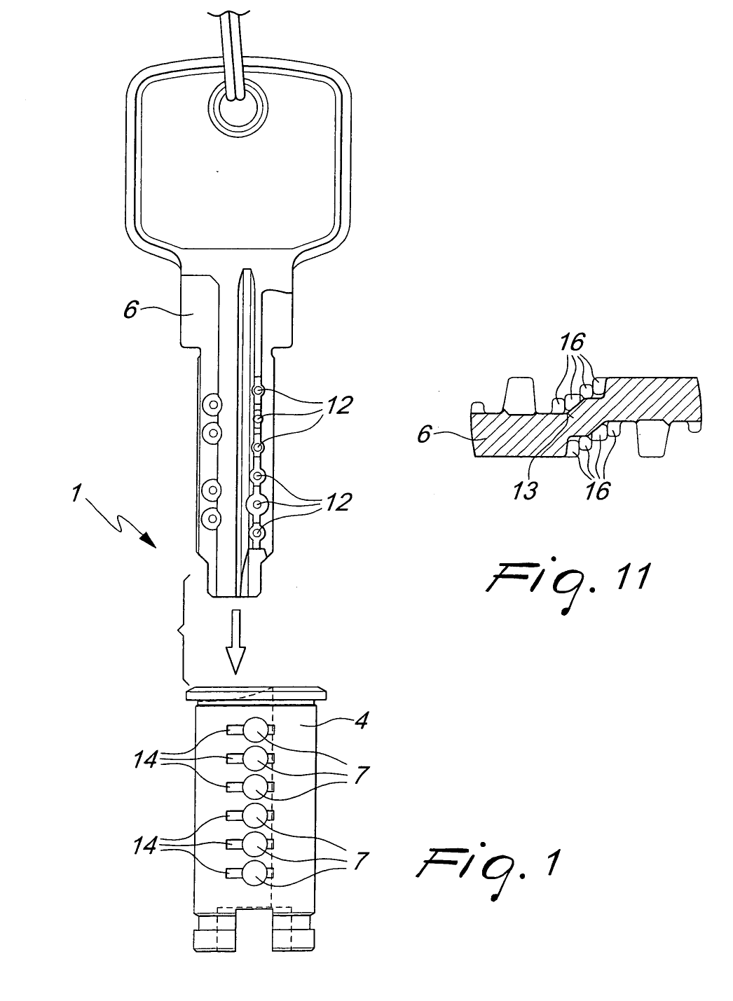

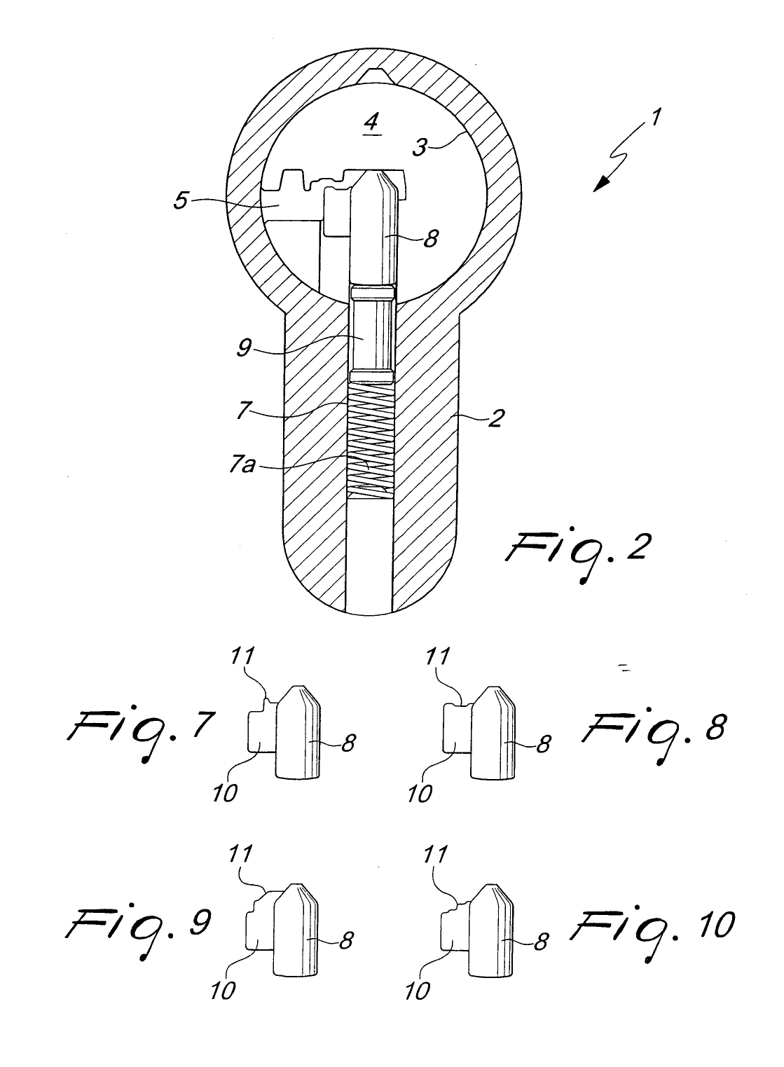

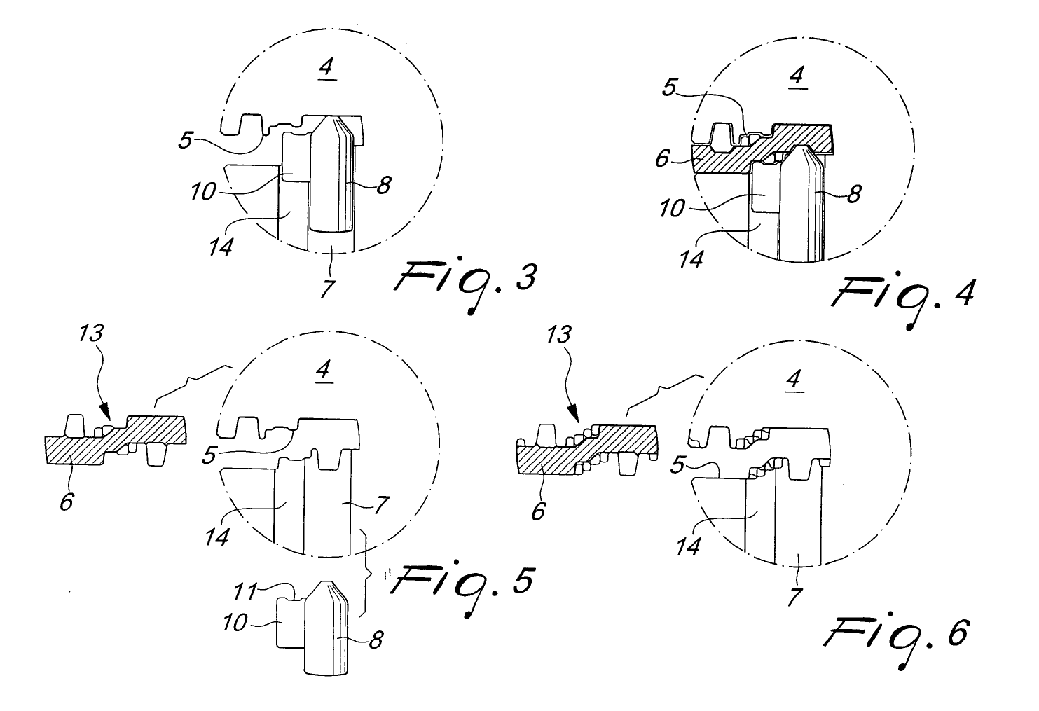

### DESCRIPTION OF THE PREFERRED EMBODIMENTS

With reference to the figures, the reference numeral 1 generally designates a lock with an associated key.

The lock 1 comprises a stator 2, which is provided with a substantially cylindrical longitudinal cavity 3 for accommodating a rotor 4 with a longitudinal recess 5 for insertion of a coded key 6.

The rotor 4 and the stator 2 comprise a plurality of channels 7, which are substantially aligned and face each other when the cylinder 1 is in the closed configuration.

The containment channels 7 are designed to accommodate respective pins 8, complementary pins 9 and optional elastic means 7a: the purpose of the pins 8 and complementary pins 9 is to prevent the rotation of the rotor 4 within the stator 2 if the key 6 is not in the longitudinal recess 5.

At least one of the pins 8 has at least one substantially lateral protruding tab 10, which has a conveniently shaped upper rim 11.

The key 6 has a cross-section which is complementary to the cross-section of the longitudinal recess 5, in particular when the pins 8 are in the configuration for disengaging the stator 2 and the rotor 4: i.e., when the surface of discontinuity between the pin 8 and the complementary pin 9 is aligned with the surface of discontinuity between the stator 2 and the rotor 4. The key 6 therefore accommodates, with contact against it, the end of the pins 8 in respective coding recesses 12 and the contoured rim 11 of the corresponding tab 10 on suitable complementarily shaped portions 13.

The channels 7 of the rotor 4 have a lateral slot 14 for slidingly accommodating the tab 10 of the pins 8.

The tab 10 has, on its upper surface, a plurality of abutments 15 arranged side by side, which constitutes the contoured portion 11; the abutments 15 are complementary with respect to respective thickness variations, which constitute abutment portions 16, which constitute the complementarily shaped portions 13, of the cross-section of the key 6, and are associated therewith when the key 6 is inserted in the longitudinal recess 5.

The part of the key 6 provided with the complementarily shaped abutment portions 13 is substantially the part along the longitudinal axis, because the pins 8 act on the substantially central surface of the flat face toward which they are pushed by the elastic action of the means 7a.

Depending on the constructive solution that one wishes to use, all the pins 8 (or just some, depending on the observed production requirements) also can be provided with the lateral tab 10, and the key may therefore have a succession of parts provided with complementarily shaped portions 13 distributed in a substantially longitudinal direction.

From a manufacturing standpoint, it is convenient to note that the tabs 10 can also be two and be provided, on the respective upper edge, with specific contoured abutment rims 11.

In this case, the key 6 must have a profile which comprises, on each of the mutually opposite coded faces, two complementarily shaped portions 13, which are complementary with respect to the respective contoured abutment rims 11 of the pairs of tabs 10 rigidly coupled to the pin 6.

According to embodiments which are complicated and difficult to provide in practice (but have excellent levels of security against picking and tampering), the tabs 10 can be a plurality, even only partially provided with the respective contoured rim 11.

In this case, the key 6 must have a profile which comprises, on each of the mutually opposite coded faces, a plurality of complementarily shaped portions 13 which are complementary to the respective contoured abutment rims 11.

The part of the key 6 that is provided with the complementarily shaped abutment portions 11, i.e., the part arranged substantially along the longitudinal axis of the key 6, can comprise at least one movable element.

This movability may also be only partial, for example if the movable element is constituted by a small flap pivoted in a through opening provided in the key 6.

A respective pin 8 must be associated with the movable element and be designed to move it (therefore, a pin 8 having a shape and dimensions suitable for the purpose) in the configuration for protruding from the contour of the key 6 by way of the action of the elastic means 7a.

It has thus been shown that the invention achieves the proposed aim and objects.

The invention thus conceived is susceptible of numerous modifications and variations, all of which are within the scope of the appended claims.

All the details may further be replaced with other technically equivalent ones.

In the exemplary embodiments that follow, individual characteristics, given in relation to specific examples, may actually be interchanged with other different characteristics that exist in other exemplary embodiments.

Moreover, it is noted that anything found to be already known during the patenting process is understood not to be claimed and to be the subject of a disclaimer.

In practice, the materials used, as well as the shapes and the dimensions, may be any according to requirements without thereby abandoning the scope of the protection of the appended claims.

The disclosures in European Patent Application No. 06425402.2 from which this application claims priority are incorporated herein by reference.

What is claimed is:

1-9. (canceled)

10. A lock with associated key, of the type comprising a stator provided with a substantially cylindrical longitudinal cavity for accommodating a rotor with a longitudinal recess for the insertion of a coded key, said rotor and said stator comprising a plurality of channels, which are substantially aligned and face each other when the cylinder is in the closed configuration, channels for accommodating respective pins, complementary pins and optional elastic means intended to prevent the rotation of the rotor within the stator if the key is not present in said longitudinal recess, wherein at least one of said pins has at least one substantially lateral protruding tab, whose upper rim is suitably contoured, and in that said key has a cross-section that is complementary to the cross-section of the longitudinal recess when said pins, at the regions aligned with said tab, are in a configuration for disengaging the stator and the rotor, accommodating with contact the end of said pins in respective coding recesses and the contoured rim of the corresponding tab on complementarily shaped portions.

11. The lock according to claim 10, wherein said channels have a lateral slot for slidingly accommodating said tab of said pins.

12. The lock according to claim 10, wherein said tab has, on its upper surface, a plurality of side-by-side abutments, which constitute said contoured portion, said abutments being shaped complementarily with respect to respective thickness variations which constitute abutment portions, which form the complementarily shaped portions, of the cross-section of the key and are associated therewith when said key is inserted in said longitudinal recess.

13. The lock according to claim 12, wherein a part of said key that is provided with said complementarily shaped abutment portions is substantially the part arranged along the longitudinal axis.

14. The lock according to claim 12, wherein all said pins are each provided with said lateral tab and said key has a succession of parts provided with complementarily shaped portions distributed in a substantially longitudinal direction.

15. The lock according to claim 10, wherein said tabs are two and are provided, on the respective upper edge, with specific contoured abutment rims.

16. The lock according to claim 15, wherein said key has a profile which comprises, on each of the mutually opposite coded faces, two portions shaped complementarily with respect to the respective contoured abutment rims of said pair of tabs rigidly coupled to said pin.

17. The lock according to claim 10, wherein said tabs are a plurality and are even only partially provided with the respective contoured rim, and in that said key has a profile which comprises, on each of the mutually opposite coded faces, a plurality of portions shaped complementarily with respect to the respective contoured abutment rims.

18. The lock according to claim 13, wherein the part of said key that is provided with said complementarily shaped abutment portions and is arranged substantially along the longitudinal axis comprises at least one element which can move, even partially, and is associated with a respective pin designed to move it into a configuration for protruding from the contour of said key by way of the action of said elastic means.
